(19) United States
(12) Patent Application Publication
(10) Pub. No.: US 2004/0093973 A1
(43) Pub. Date: May 20, 2004

(54) Ball screw

(76) Inventors: Georg Halasy-Wimmer, Markgroningen (DE); Ulrich Neumann, Rossdorf (DE); Johann Jungbecker, Badenheim (DE); Stefan Schmitt, Eltville (DE); Jurgen Volkel, Frankfurt (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/399,811

(22) PCT Filed: Oct. 18, 2001
(86) PCT No.: PCT/EP01/12074

(30) Foreign Application Priority Data
Oct. 23, 2000 (DE) 100 52 504.0
Jun. 11, 2001 (DE) 101 28 252.4

(51) Int. Cl. F16H 1/16

(52) U.S. Cl. 74/424.85

(57) ABSTRACT

The invention relates to a ball screw comprising a threaded nut, a threaded spindle, supporting rolling bodies, which are provided in the form of balls rotating inside thread grooves of the threaded nut as well as of the threaded spindle, and comprising a return area for the balls. In order to considerably reduce the manufacturing costs, especially by a non-cutting fabrication of the threaded nut, and to obtain a higher power density by homogenizing the contact area percentage of the ball screw, the threaded nut is comprised of a helically wound profile material according to the invention. The invention relates to a ball screw comprising a threaded nut (2), a threaded spindle (1), supporting rolling bodies (3), which are provided in the form of balls rotating inside thread grooves (5,4) of the threaded nut (2) as well as of the threaded spindle (1), and comprising a return area (6) for the balls (3).

In order to considerably reduce the manufacturing costs, especially by a non-cutting fabrication of the threaded nut, and to obtain a higher power density by homogenizing the contact area percentage of the ball screw, the threaded nut (2) is comprised of a helically wound profile material (7) according to the invention.

The present invention relates to a ball screw with a threaded nut, a threaded spindle, and supporting rolling bodies, which are designed as balls rotating inside thread grooves of the threaded nut as well as of the threaded spindle, and comprising a return area for the balls.

A ball screw of this type is disclosed in international patent application WO 98/36186. The special features of this prior art ball screw involve that the threaded nut is encompassed by another nut and mounted in said nut by means of rolling bodies, with the nut being axially held as external nut in a stationary housing.

A disadvantage from which the prior art ball screw suffers is in particular the necessity of manufacturing the threaded nut by chip-cutting machining, incurring high manufacturing costs.

Therefore, an object of the present invention is to disclose a ball screw of the type mentioned hereinabove achieving a considerable reduction of manufacturing costs due to non-cutting fabrication.

According to the present invention, this object is achieved in that the threaded nut is composed of a helically wound profile material or a helically wound wire material with a circular cross-section that is arranged in a sleeve. The profile material is provided in the form of bars or endless material. The elasticity of the wound threaded nut permits an increase of the power density and a homogenized contact area percentage.

In a favorable improvement of the subject matter of the invention, the windings of the helically wound profile material adopt the coil bound length and are arranged under bias in a sleeve.

The windings in coil bound length of the helically wound profile material are preferably arranged in the sleeve in a non-rotatable manner. It is achieved thereby that the reaction moment that is produced by the conversion of a rotation into a translational motion is transmitted onto the sleeve. Appropriate anti-rotation mechanisms are, for example, axial or radial profiles or recesses of the windings.

The raceway for the balls is preferably formed by a concave profiling of the profile material or by two concave profiles of respectively two side-by-side arranged windings of the profile material.

At least one block contact surface of the profile material has a convex configuration, or both block contact surfaces of the profile material have a plane design.

According to another feature of the invention the rigidity of the threaded nut is enhanced because the windings of the profile material are welded.

It is especially favorable that the return area for the balls is designed in the threaded spindle.

The present invention will be explained in more detail in the following description of two embodiments by making reference to the accompanying drawings. In the drawings,

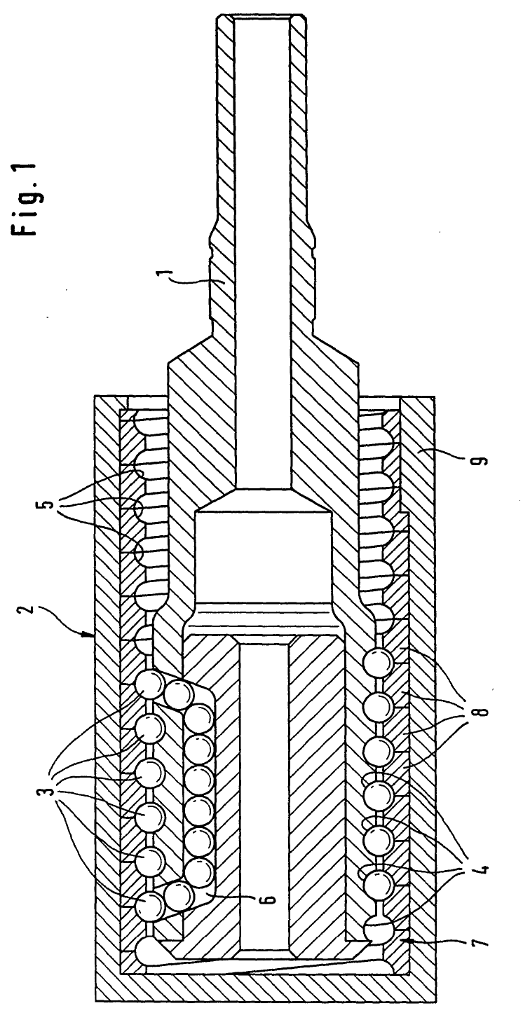

FIG. 1 is an axial sectional view of a first embodiment of the ball screw of the invention.

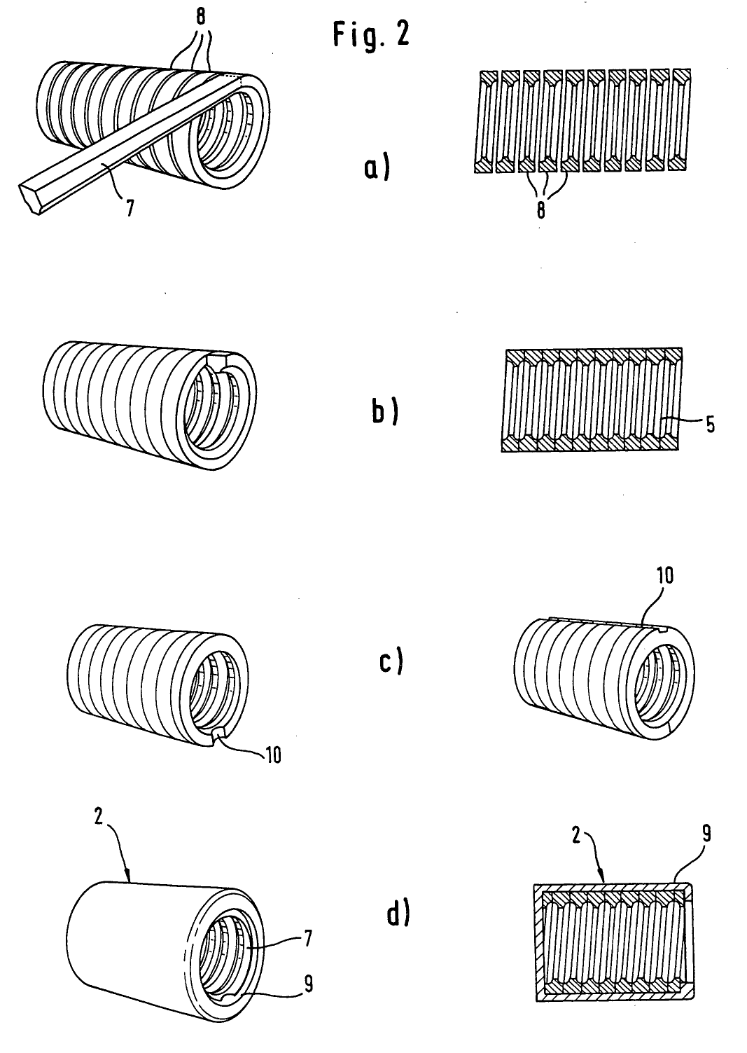

FIG. 2 is a schematic view of a method of manufacturing the threaded nut of the ball screw shown in FIG. 1.

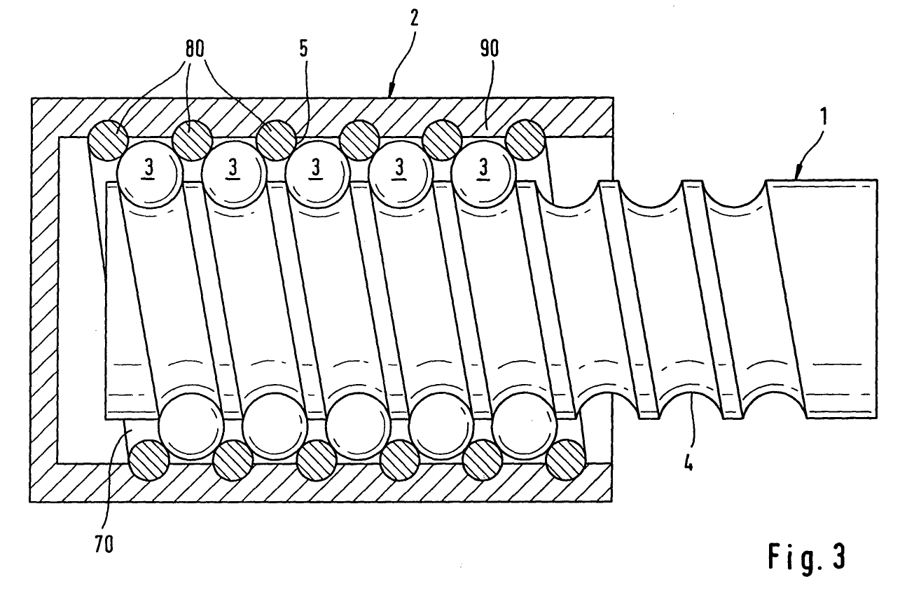

FIG. 3 is a simplified illustration of the second embodiment of the ball screw of the invention in an axial sectional view.

The first design of the invention ball screw illustrated in FIG. 1 is essentially composed of a threaded spindle 1, a threaded nut 2 encompassing the threaded spindle 1, as well as a plurality of supporting rolling bodies 3 interposed between threaded spindle 1 and threaded nut 2. Both the threaded spindle 1 and the threaded nut 2 are mounted in a housing not shown, with the threaded nut 2 being secured against rotation so that it can be set into an axial or translational motion. Used as a raceway for the rolling bodies 3 configured as balls is, on the one hand, a helical thread groove 4 provided in the threaded spindle 1 and, on the other hand, a helical thread groove 5 that is shaped so as to mate with the threaded nut 2. Furthermore, a return area or channel 6 is provided within the threaded spindle 1 in which the balls 3 can return without load to the start of the carrying raceway.

As can further be taken from FIG. 1, the threaded nut 2 is produced by several windings 8 of a helically wound profile material 7, said windings being arranged in a sleeve designated by reference numeral 9. The above-mentioned thread groove 5 is preferably formed by two concave profiles of two windings 8 arranged side-by-side.

FIG. 2 illustrates the individual steps a-d of a method of manufacturing the threaded nut 2. In the first step (a), the bar material or endless material 7 profiled in cross-section is helically wound similar to a cylindrical spring. The final ball raceway or threaded groove 5 is achieved when the cylindrical thread arrangement is preloaded to coil bound length in step b, with the largest width of the rod cross-section determining the pitch of the threaded nut 2. Both block contact surfaces of the profile material 7 have a plane design, while also a design is conceivable wherein one of the block contact surfaces has a convex configuration. In step c, the end areas of the cylindrical thread arrangement are axially ground, and a radial recess 10 is formed into their surface. Finally, the arrangement is inserted into the above-mentioned sleeve 9 in step d, with the result that the final geometry and the necessary rigidity are reached under bias. The radial recess 10 is preferably used to support the reaction moment that is produced by the conversion of the rotation into the translational motion during operation of the ball screw of the invention. Of course, other appropriate measures are also possible. Thus, e.g. sleeve 9 can be welded to the cylindrical thread arrangement. It is also possible to obviate the sleeve 9 and weld the individual windings 8 that are biased to coil bound length.

The above-described type of manufacture allows the geometry of the threaded nut 2 made in non-cutting machining (diameter, length, thread pitch, number of supporting circulations) to vary within wide limits. Because the final geometry is determined by the precision of the rod cross-section and the assembly of the thread arrangement in the sleeve under preload, the tolerances for winding may be kept to be relatively wide, whereby cost reduction is achieved. The rigidity of the threaded nut can be rated in a defined manner by an appropriate profiling of the rod cross-section, with a view to compensating manufacturing inaccuracies of the threaded spindle 1, especially pitch errors, by way of elastic deformations.

FIG. 3 shows an especially low-cost design of the threaded nut 2. In the embodiment shown, the cylindrical thread arrangement is composed of a helically wound wire material 70 with a preferably circular cross-section, and the above-mentioned thread groove 5 used as a raceway for the balls 3 is formed by surface portions of respectively two spaced windings 80. The helical, spring-type arrangement is inserted into a metallic sleeve 90 with a correspondingly shaped profiling.

1. Ball screw with a threaded nut (2), a threaded spindle (1), supporting rolling bodies (3), which are designed as balls rotating inside thread grooves (5,4) of the threaded nut (2) as well as of the threaded spindle (1), and comprising a return area (6) for the balls (3),
characterized in that the threaded nut (2) comprises a helically wound profile material (7).

2. Ball screw with a threaded nut (2), a threaded spindle (1), as well as supporting rolling bodies (3), which are designed as balls rotating inside thread grooves (5,4) of the threaded nut (2) as well as of the threaded spindle (1),
characterized in that the threaded nut (20) is comprised of a helically wound wire material (70) with a circular cross-section that is arranged in a sleeve (90).

3. Ball screw as claimed in claim 1,
characterized in that the windings (8) of the helically wound profile material (7) are set to coil bound length and are arranged under bias in a sleeve (9).

4. Ball screw as claimed in claim 3,
characterized in that the windings (8) set to coil bound length of the helically wound profile material (7) are arranged in the sleeve (9) in a non-rotatable manner.

5. Ball screw as claimed in claim 4,
characterized in that the anti-rotation mechanism is a radial recess (10) of the windings (8).

6. Ball screw as claimed in claim 4,
characterized in that the anti-rotation mechanism is provided by welding the windings (8) to the sleeve (9).

7. Ball screw as claimed in any one of claims 1, 3 to 6,
characterized in that the raceway for the balls is formed by way of a concave profiling of the profile material.

8. Ball screw as claimed in any one of claims 1, 3 to 6,
characterized in that the raceway (5) for the balls (3) is formed by way of two concave profilings of respectively two side-by-side arranged windings (8) of the profile material (7).

9. Ball screw as claimed in any one of claims 1 or 3 to 8,
characterized in that both block contact surfaces of the profile material (7) have a plane design.

10. Ball screw as claimed in any one of claims 1 or 3 to 8,
characterized in that at least one block contact surface of the profile material (7) has a convex design.

11. Ball screw as claimed in any one of claims 1 or 3 to 10,
characterized in that the windings of the profile material are welded.

12. Ball screw as claimed in any one of claims 1 to 11,
characterized in that the return area (6) for the balls (3) is designed in the threaded spindle (1).
